(19) United States
(12) Patent Application Publication
(10) Pub. No.: US 2007/0141203 A1
(43) Pub. Date: Jun. 21, 2007

(54) Beverages containing water-soluble vitamin E

(76) Inventor: Phillip Michael Cook, Kingsport, TN (US)

Correspondence Address: Brett L. Nelson;Eastman Chemical Company, P.O. Box 511, Kingsport, TN, 37662-5075, US

(21) Appl. No.: 11/705,348

(22) Filed: Feb. 12, 2007

Related U.S. Application Data
(63) Continuation of application No. 10/788,795, filed on Feb. 27, 2004.
(60) Provisional application No. 60/466,265, filed on Apr. 29, 2003.

(51) Int. Cl. A23L 1/30

(52) U.S. Cl. 426/72

(57) ABSTRACT

The present invention relates to beverage compositions that have the added benefit of providing a water-soluble source of Vitamin E. For example, d,l- or d-α-tocopheryl polyethylene glycol 1000 succinate (such as Vitamin E TPGS™) may be used to provide tocopheryl (i.e., vitamin E) content to beverages while concurrently maintaining beverage clarity when desired. Various additives may also be used in the beverage compositions of the present invention, such as flavoring agents, colorants, preservatives, sweeteners as well as other vitamins, minerals and/or electrolytes.

This application is a continuation of U.S. application Ser. No. 10/788,795 filed Feb. 27, 2004, which claims the benefit of U.S. Provisional Application Ser. No. 60/466,265, filed Apr. 29, 2003.

This invention relates to beverage compositions that have the added benefit of providing a water-soluble source of vitamin E. In particular, d,l- or d-α-tocopheryl polyethylene glycol 1000 succinate (e.g., Vitamin E TPGS™) may be used to provide tocopheryl (i.e., vitamin E) content to beverages while concurrently maintaining beverage clarity, when desired.

### BACKGROUND

In recent years there has been a significant increase in demand for alternatives to conventional beverages, including a demand for those that can provide health benefits to the consumer beyond simple re-hydration. Specifically, vitamin, mineral and/or electrolyte fortified beverages are of significant interest; an important and desired vitamin for inclusion in such beverages is vitamin E, which is not water-soluble making it difficult to incorporate into such beverages. In addition, significant interest has arisen for beverages to be clear and/or colorless.

Natural vitamin E comprises at least eight types of homologs (four tocopherols and four tocotrienols), of which d-α-tocopherol is the most abundant and the most biologically active. Synthetic vitamin E is a mixture of d-forms and l-forms that are optical isomers of each other. Natural vitamin E consists of only the d-form. Thus, the synthetic form of vitamin E is designated as d,l-α-tocopherol, while the natural form is designated as d-α-tocopherol. In either case, only the d-form is active. These vitamin E homologues are widely distributed in nature and found in such foods as grains, green plants, algae, vegetables, vegetable oils, fish, and meat. The biological activity of vitamin E in each of these food items can differ significantly.

Vitamin E compounds are usually produced and made available in esterified form as d- or d,l-α-tocopheryl acetate or d- or d,l-α-tocopheryl succinate. Neither of these forms has much, if any, antioxidant activity until converted to d- or d,l-α-tocopherol in the body, but they are much more stable with respect to storage time and temperature than the non-esterified forms. Moreover, while the acetate form is rapidly activated within the body, activation of the succinate form is slower. Further, the succinate form appears to access and benefit areas of tissues that are unavailable to the other forms. For this reason, d- or d,l-α-tocopherol succinate is generally considered a distinctly different and beneficial compound. It appears to have longer half-life in the body, less effect on blood clotting, and does not interfere with vitamin A and K absorption. It is also more beneficial for cancer therapy according to several published studies.

A third form of vitamin E is Vitamin E TPGS™, available from Eastman Chemical Company. Vitamin E TPGS™ is a water-soluble form of natural-source vitamin E. The solubility of Vitamin E TPGS™ in water is at least 200 g/L, while the solubility of natural or synthetic vitamin E, and their acetate and succinate ester forms, in water is less than 1 g/L. A corresponding product prepared from synthetic source vitamin E is known as Vitamin E DL TPGS™, also available from Eastman Chemical Company. In either case, the commercial product is prepared by esterifying the carboxyl group of crystalline d-α-tocopheryl acid succinate (or the d,l-form in the case of synthetic vitamin E) with polyethylene glycol 1000. Vitamin E TPGS™ is very stable and does not hydrolyze under normal conditions. It is essentially tasteless and odorless and has been shown to be a readily bioavailable source of vitamin E for individuals or animals having difficulties absorbing naturally occurring, fat-soluble vitamin E. Thus, its therapeutic benefit has been well documented and recognized.

When supplementing beverages with vitamins, minerals and/or electrolytes, it is often desirable to preserve the optical clarity of the beverage. Fat-soluble vitamins such as vitamin E, however, will tend to increase the visible turbidity of beverages when added. In addition, a phenomenon known as “ringing” is a problem that vitamin formulations have not solved; ringing is the formation of a separate fat-soluble vitamin layer on the top of the liquid. One method of adding vitamin E to beverages without increasing visible turbidity or ringing is to encapsulate the vitamin in liposomes. This is a costly process, however, and the concentration of active substance in the liposome tends to be low. Moreover, a major problem when using liposomes in food technology is their instability and ability to sequester water-insoluble ingredients such as flavors and micronutrients.

An alternative approach purported to make such aqueous dispersions with optical clarity is to make aqueous microdispersions or nanodispersions in which the dispersed oil droplets of vitamin E, or its acetate or succinate esters, are less than about 200 nanometers. Since this particle size is well below the wavelength of visible light, the particles will not reflect and diffract the light, and thus would not be visually detectable. Upon storage, however, such microdispersions tend to be unstable. Perhaps even more important is the fact that microdispersions and nanodispersions by necessity require dilute concentrations else they will begin to agglomerate making larger particles that begin to reflect and diffract light as they increase in size.

For example, U.S. Pat. No. 4,835,002 to Wolf et al. describes the preparation of microemulsions having particles too small to be visually detected. These emulsions are formed from water, alcohol, an essential oil, and one or more emulsifying agents or surfactants. U.S. Pat. No. 5,798,333 to Sherman discloses a homogenous, water-soluble concentrate of cyclosporin that can be diluted in an aqueous solution without precipitating cyclosporin. The concentrate comprises cyclosporin in combination with tocophersolan (d-α-tocopheryl polyethylene glycol 1000 succinate) dissolved in a hydrophilic organic solvent, such as propylene glycol. Solvent-free compositions are not disclosed, as they would likely be unstable or inhomogeneous.

U.S. Pat. No. 6,180,130 to Chen et al. describes vitamin preparations for beverage applications. Exemplified is the use of polyoxyethylene (20) sorbitan mono-oleate (Polysorbate 80) to prepare microdispersions of vitamin E acetate for use in beverages. U.S. Pat. No. 6,426,078 to Bauer et al. describes oil in water microemulsions that comprise at least one polyglycol ester as an emulsifier, and at least one lipophilic substance selected from the group consisting of carotenoids, vitamin A and its derivatives, vitamin D and its derivatives, vitamin E and its derivatives, vitamin K and its derivatives, and polyunsaturated fatty acids, and combinations thereof, and water.

### BRIEF SUMMARY OF THE INVENTION

The present invention provides beverage compositions that have the added benefit of providing a water-soluble source of Vitamin E. In particular, d,l- or d-α-tocopheryl polyethylene glycol succinate (e.g., Vitamin E TPGS™ or Vitamin E DL TPGS™) may be used to provide tocopheryl (i.e., vitamin E) content to beverages. The invention provides a beverage comprising water, a water-soluble source of vitamin E, one or more flavoring agents and one or more sweeteners. In addition, the invention provides a fruit beverage comprising fruit juice or fruit flavoring, a water-soluble source of vitamin E, and water; the fruit beverage may also contain natural or artificial sweeteners.

The beverage compositions of the present invention may be carbonated or non-carbonated and may contain a variety of flavoring agents and/or sweeteners. It may also be beneficial to include a preservative or, optionally, an anti-foaming agent in the beverage. In certain applications, ethanol (ethyl alcohol) may be present.

If desired, the tocopheryl content contemplated by the present invention may be added to a beverage without sacrificing optical clarity of the beverage and without the need of an emulsifier. Typically, the water-soluble source of vitamin E will be present in a nutritionally supplemental amount.

### DETAILED DESCRIPTION OF THE INVENTION

As stated above, the present invention is a beverage comprising water, a water soluble source of vitamin E (e.g., Vitamin E TPGS™), a flavoring agent and a sweetener. The present invention also provides for a fruit beverage comprising fruit juice or fruit flavoring, a water-soluble source of vitamin E, and water. In addition, the beverages of the present invention include a carbonated beverage comprising carbonated water, a water-soluble source of vitamin E, and a flavoring agent.

As noted above, the present invention employs a water-soluble form of the normally hydrophobic vitamin E. Readily available forms of water-soluble vitamin E include the naturally derived product Vitamin E TPGS™ and the synthetically derived product Vitamin E DL TPGS™. As noted above, the commercial products are prepared by esterifying the carboxyl group of crystalline d-α-tocopheryl acid succinate (or the d,l-form in the case of synthetic vitamin E) with a polyethylene glycol (or “PEG”) molecule. While the commercially available forms employ polyethylene glycol 1000 in this esterification, other forms of PEG having molecular weights of about 200 to about 20,000 may be used; typical molecular weights for the PEG that may be employed include polyethylene glycol 200, 400, 600, 800, 1000 and so on. More particular examples of suitable polyethylene glycols are those having molecular weights of 400 or 1000 (PEG 400 and PEG 1000, respectively).

The amount of the water-soluble vitamin E present in a beverage according to the present invention can be expressed in a variety of ways, any of which will be understood by the skilled artisan. A common way to express vitamin E content is in International Units (IU), one IU being 0.67 milligram of d-α-tocopherol or 1 mg of d,l-α-tocopherol. Thus, according to the present invention, the water soluble source of vitamin E should provide to the beverage a tocopheryl content of about 0.0005 IU/ml to about 10 IU/ml. Preferably, the beverage would have a tocopheryl content of about 0.002 IU/ml to about 2 IU/ml; more preferably, the tocopheryl content would be about 0.02 IU/ml to about 1 IU/ml.

In addition, the amount of water-soluble vitamin E may be expressed in parts per million (ppm). For example, when the water-soluble source of vitamin E is d,l- or d-α-tocopheryl polyethylene glycol 1000 succinate (e.g., Vitamin E TPGS™ or Vitamin E DL TPGS™) the concentration may be about 1 to about 20,000 ppm. For a 16 ounce beverage, the foregoing range would equate to about 0.0005 to about 9.5 grams of d-α-tocopheryl polyethylene glycol 1000 succinate, which would equal about 0.14 to about 2660 mg of d-α-tocopherol (about 0.2 to about 3962 IU). The approximate average potency of Vitamin E TPGS™ is 417 IU/g. Preferably, the amount of Vitamin E TPGS™ is from about 1 to about 2500 ppm, and more preferably about 10 to about 1000 ppm.

Sweeteners that may be used herein include any of the naturally occurring sugars that are widely commercially available, such as glucose, sucrose, dextrose, and fructose; in addition to being available separately, the foregoing are also generally found naturally in various fruit juices. Other sugars that may be used include high fructose corn syrup, invert syrup, sugar alcohols, including sorbitol, mannitol, lactitol, refiner's syrup, and mixtures thereof. In addition to sugars, other suitable sweeteners include low or non-caloric sweeteners such as acesulfame potassium, alitame, sucralose, saccharin, cyclamates, and L-aspartyl-L-phenylalanine lower alkyl ester sweeteners (e.g., LL-aspartame). The foregoing sweeteners may be used in various combinations depending on the desired sweetness, taste or nutritive effect desired. Particularly preferred artificial sweeteners are sucralose, acesulfame potassium and LL-aspartame.

The amount of sweetener effective for use in the beverages of the invention depends upon the particular sweetener used and the sweetness intensity desired. For non-caloric sweeteners, this amount varies depending upon the sweetness intensity of the particular sweetener. For a naturally occurring sugar such as sucrose, for example, this amount can be from about 1% to about 14% (typically from about 6% to about 14%) by weight for carbonated or still (or non-carbonated) beverages. Preferred beverages contain from about 9% to about 13% by weight sugar. In determining the amount of sugar for beverages of the present invention, any sugar or other sweetener present in the flavor component, such as in fruit juice, is also included. Low-calorie sweetener combinations containing a non-caloric sweetener such as aspartame and a sugar such as high fructose corn syrup can also be used in beverages.

The flavoring agents used in the present invention may be various fruit and/or vegetable flavors such as grape, pear, passion fruit, pineapple, banana or banana puree, apricot, citrus, orange, peach, lemon, grapefruit, apple, cranberry, tomato, mango, papaya, lime, tangerine, cherry, blueberry, strawberry, blackberry, raspberry, coconut, carrot and mixtures thereof. The fruit flavors may be derived from naturally occurring fruit juices and/or extracts, fruit oils, or they may be synthetically prepared. When a naturally derived source of flavoring such as fruit juice is used, the flavoring may also serve as a natural source of sweetener. Other, non-fruit flavoring agents that may be used in the present invention include cola, mint, chocolate, almond, peanuts or other nuts, fudge, vanilla, coffee, tea, latte, cappuccino, butterscotch and mixtures thereof. The skilled artisan will recognize that the foregoing list of flavors is exemplary only, and is not meant to be limiting. Further, and depending upon the desired characteristics of the final beverage, one may desire to combine one or more fruit and/or vegetable flavoring agents with one or more of the non-fruit variety. As used herein, the terms flavorant, flavoring agent and flavoring are used interchangeably.

A flavoring package can comprise a blend of various flavors, e.g. lemon and lime flavors, cola flavors and citrus flavors to form cola flavors, etc. If desired, fruit juices such as orange, lemon, lime, apple, grape and like juices can be used in the flavoring package. The flavoring(s) in the flavoring package are sometimes formed into emulsion droplets that are then dispersed in a beverage concentrate. Because these droplets usually have a specific gravity less than that of water, and would therefore form a separate phase, weighting agents (which may also act as clouding agents) are typically used to keep the emulsion droplets dispersed in the beverage. Examples of such weighting agents are sucrose acetate isobutyrate (SAIB) or brominated vegetable oils (BVO) and rosin esters, in particular the ester gums. Besides weighting agents, emulsifiers and emulsion stabilizers can be used to stabilize the flavoring emulsion droplets. Examples of such emulsifiers and emulsion stabilizers include the gums, pectins, celluloses, polysorbates, sorbitan esters and propylene glycol alginates.

The particular amount of the flavoring agent that is effective for imparting flavor characteristics to the beverages and beverage concentrates can depend upon the flavor(s) selected, the flavor impression desired, and the form of the flavor component. The flavor component can comprise at least about 0.05% up to about 15% by weight of the final beverage composition, and typically from about 0.1% to about 2% by weight. When fruit juices are used as the flavoring, the flavoring agent can comprise, on a single-strength basis, from about 2% up to about 25% fruit juice by weight of the beverage, preferably from 5% to 15% fruit juice by weight for carbonated beverages.

As used herein, a “fruit beverage” is a fruit flavored or fruit juice product that is in a single-strength, ready-to-serve, drinkable form. Fruit beverages of the present invention may be of the “full-strength” type, which typically comprise from about 1% to about 99%, and preferably at least about 90% and more preferably about 95% fruit juice. Full strength fruit juice beverages also include those products identified as 100% fruit juice such as, for example, orange, apple, raspberry, cherry, apricot, pear, grapefruit, grape, lime, tangerine, carrot, pineapple, cranberry, tomato, and various mixtures thereof. Fruit beverages also include extended juice products that are referred to as “nectars.” These extended juice products typically comprise from about 50% to about 90% fruit juice, preferably, from about 50% to about 70% fruit juice. Nectars usually have added sugars or artificial sweeteners or carbohydrate substitutes.

For single-strength beverages sweetened with sucrose, the sugar content can range from about 2 Brix to about 16 Brix. Typically, the sugar content of such beverages depends upon the amount of fruit juice contained therein. For full-strength beverages containing at least about 95% fruit juice, the sugar content is typically from about 5 to 14 Brix. For extended beverages that comprise from about 50% to about 90% fruit juice, the sugar content is typically from about 5 to about 13 Brix (no other sweetener) or from about 2 to about 8 Brix (other sweetener containing). For fruit juice concentrates according to the present invention, the sugar content can range from about 6 to about 75 Brix. Typically, the sugar content of these juice concentrates is from about 20 to about 50 Brix. For orange juice concentrates, the sugar content is preferably from about 35 to 50 Brix.

The beverages of the present invention may be carbonated beverages such as flavored seltzer waters, soft drinks or mineral drinks, as well as non-carbonated waters, fruit juices, fruit punches and concentrated forms of such beverages. When a carbonated beverage is desired, carbon dioxide may be introduced into the water that is mixed with the beverage concentrate (or syrup); alternatively, the carbon dioxide may be introduced into the drinkable beverage after dilution to achieve carbonation. The carbonated beverage can be placed into a container such as a bottle or can and then sealed. Any conventional carbonation methodology can be used to make the carbonated beverages of this invention.

The amount of carbon dioxide introduced into the beverage will depend upon the particular flavor system used and the amount of carbonation desired. Usually, carbonated beverages of the present invention contain from about 1.0 to about 9.0 g/L carbon dioxide.

The beverages of the present invention may also include alcohol-containing beverages having about 1% to about 10% by weight ethanol; more typically, the ethanol content would be about 3% to about 9% by weight, or about 3% to about 6% by weight. Examples include beer and malt beverages containing up to about 6% by weight ethanol and wine coolers containing up to about 9% by weight ethanol.

In addition to the water-soluble source of vitamin E, the beverages of the present invention may include a variety of other beneficial substances such as other water-soluble vitamins, minerals and/or electrolytes. Additional vitamins that may be present in the invention include ascorbic acid (Vitamin C), Vitamins B1 (thiamin), B2 (riboflavin), B6 (pyridoxamine) and B12 (cyanocobalamine) and Vitamin B complexes. Components of a Vitamin B complex include vitamins B1, B2, B6, B12, biotin, niacin, pantothenic acid, folic acid, adenine, choline, adenosine phosphate, orotic acid, pangamic acid, carnitine, 4-aminobenzoic acid, myo-inositol, liponic acid and/or amygdaline. Beneficial minerals that may be included in the beverages include calcium, iron, magnesium and zinc. Electrolytes that would be suitable for inclusion include sodium, potassium and magnesium in the form of their chloride and/or bicarbonate salts.

Also contemplated in the present invention are dairy products, particularly milk products, containing water-soluble source of vitamin E. The milk products contemplated herein may be derived from animals (e.g., cows) or synthetically prepared, and includes both whole milk and various reduced fat forms. To the foregoing may be added a solution of water-soluble source of vitamin E, to present a dairy product having the amount of water-soluble source of vitamin E identified above. The foregoing may also include any of the above-mentioned sweeteners, flavoring agents, preservatives and/or vitamins, including Vitamin D, minerals or electrolytes.

As stated above, an anti-foaming agent (or antifoamant) may optionally be used in the various embodiments contemplated herein, including the beverages or beverage concentrates. Any of the numerous and commercially available anti-foaming agents that are suitable for use in food products would be suitable for use herein. Common antifoam agents approved for use in foods include: dimethylpolysiloxane, methylphenylpolysiloxane, oxystearin, polyethylene glycol dioleate, polyethylene/polypropylene glycol copolymers, Polysorbate 60, sodium monooleate, and/or mixtures thereof.

The skilled artisan will recognize that it generally may be beneficial to include a preservative in the beverages of the present invention. Suitable preservatives include sorbates and sorbate derivatives, citric acid/sodium benzoate, or mixtures thereof. The foregoing preservatives are particularly useful when a clear or substantially clear beverage product is desired. Other preservatives that may be used when beverage clarity is not required include, for example, include Tenox™ TBHQ, Tenox™ BHA, and Tenox™ BHT, all of which are available from Eastman Chemical Company.

As stated above, it is an object of the present invention to provide, when desired, an optically clear beverage composition containing d- or d,l-α-tocopheryl polyethylene glycol succinate in a nutritionally supplemental amount. Thus, the present invention supplies tocopheryl content (i.e., vitamin E) to beverages without using emulsifying or other auxiliary reagents to suspend or emulsify the vitamin E oil or water-immiscible derivatives thereof, while still maintaining beverage clarity when and if desired. That is, the beverages of the present invention may be substantially free of emulsifiers or auxiliary agents.

An example of the present invention is set forth below (Example 3), in the form of a sports drink or sports beverage. Typical sport beverages contain water, sucrose syrup, glucose-fructose syrup, natural or artificial flavors, and electrolytes. These beverages can also contain citric acid, sodium citrate, monopotassium phosphate, as well as other materials that are useful in replenishing electrolytes lost during perspiration. To this mixture, is added a water-soluble vitamin E without sacrificing the optical clarity of the sports beverage.

Typical beverage compositions comprise at least about 0.05% by weight up to about 10% of flavoring agent or at least about 3% by weight up to about 15% by weight flavoring agent, a nutritionally supplemental amount of a water-soluble source of vitamin E, and other vitamins added as an optically clear composition, water if necessary to bring the weight of the beverage to 100%, and optionally, a sweetener.

The present invention also is directed to a fruit juice/beverage concentrate or a beverage concentrates comprising a flavoring agent, a sweetener, a preservative, a water-soluble source of vitamin E, and water. A fruit juice concentrate is a fruit juice product which, when diluted with the appropriate amount of water, forms drinkable fruit juice beverages. Fruit juice concentrates within the scope of the present invention are typically formulated to provide drinkable beverages when diluted with 3 to 5 parts by weight water. Such fruit juice concentrates, may include other fruit juice materials such as fruit juice aroma and flavor volatiles, peel oils, and pulp. A beverage concentrate herein is a mixture of flavoring agents, a water-soluble source of vitamin E, water and from about 1% to about 60% sugar or sugar substitute (e.g., sweetener) based on weight. For beverage syrups, the amount of sugar is preferably from about 40% to about 60%, based on the total weight.

The various beverage and beverage concentrates can be packaged in conventional packages for the particular beverage or beverage concentrates that are nutritionally supplemented by the optically clear composition of vitamins. In some instances, the concentrates are frozen.

This invention can be further illustrated by the following examples of preferred embodiments thereof, although it will be understood that these examples are included merely for purposes of illustration and are not intended to limit the scope of the invention unless otherwise specifically indicated.

### EXAMPLES

### Example 1

Addition of Eastman Vitamin E TPGS™ to demineralized water and commercially available clear beverages. This experiment shows that beverage clarity can be maintained if using Eastman Vitamin E TPGS™ alone, without the need for emulsifying or auxiliary reagents.

A 20% aqueous stock solution of Eastman Vitamin E TPGS™ in demineralized water was made by the following procedure: Approximately 200 grams of Eastman Vitamin E TPGS™ was heated at 40-45° C. in a beaker covered with aluminum foil until it melted. While waiting for the Vitamin E TPGS™ to melt, approximately 800 grams of demineralized water was heated to about 60° C. in a previously weighed beaker. The melted Vitamin E TPGS™ was then added directly to the beaker containing the hot water, the beaker was covered with aluminum foil, and then the contents were stirred using a mechanical stirrer. The solution was stirred for approximately one hour and the temperature was allowed to drift downward. The beaker was then reweighed and additional water was added if needed to bring the concentration of Vitamin E TPGS™ to 20%.

This stock solution was then used for addition of various amounts of Vitamin E TPGS™ to commercially available clear beverages. The clarity of the beverage was then measured immediately after addition of the Vitamin E TPGS™ and again after six weeks using a Hach turbidimeter Model Ratio/XR.

A water blank was used. The results were as follows:

| | | | Turbidity | | Turbidity | | | |
|---|---|---|---|---|---|---|---|---|
| | Conc. of | | (non- | | (Initially | | Turbidity | |
| Sample | TPGS in | | doped | | doped | | (six weeks | |
| Beverage | beverage | | beverage) | | beverage) | | after doping) | |
| Demin- | 151 | ppm | 0.00 | NTU¹ | 0.05 | NTU | 0.05 | NTU |
| eralized | | | | | | | | |
| water | | | | | | | | |
| Evian | 1800 | | 0.37 | | 0.45 | | 0.55 | |
| Natural | | | | | | | | |
| Spring Water | | | | | | | | |
| Motts Apple | 1400 | | 0.70 | | 1.4 | | 2.2 | |
| Juice | | | | | | | | |
| Mountain | 1400 | | 2.7 | | 3.6 | | 4.1 | |
| Lightening | | | | | | | | |
| Diet Snapple | 1500 | | 1.6 | | 2.7 | | 3.1 | |
| Ocean Spray | 1500 | | 3.6 | | 4.9 | | 5.8 | |
| White | | | | | | | | |
| Cranberry | | | | | | | | |
| Fanta | 1500 | | 0.02 | | 0.4 | | 0.5 | |
| Strawberry | | | | | | | | |
| Hansen's | 1500 | | 0.02 | | 0.72 | | 0.91 | |
| Energy | | | | | | | | |
| Water - | | | | | | | | |
| Lemon | | | | | | | | |
| Twister - | 1500 | | 1.95 | | 2.72 | | 2.99 | |
| Kiwi/ | | | | | | | | |
| Strawberry | | | | | | | | |
| Sam's | 1500 | | 0.03 | | 0.39 | | 0.46 | |
| Choice - | | | | | | | | |
| Raspberry | | | | | | | | |

NTU is a Nephelometric turbidity unit—Haze in a Gelex secondary turbidity standard of 12 NTU (Catalog number 23287-00) is just barely detectable visually against a dark background under normal overhead fluorescent lightening commonly found in offices and laboratories.

### Example 2

Preparation of aqueous dispersions and solutions of vitamin E-containing components. This experiment demonstrates the optical clarity of various aqueous solutions containing various concentrations of vitamin E and its derivatives.

Sample 1: Vitamin E oil (0.15 g) was added to 1000 g of demineralized water. The mixture was homogenized for approximately 60 minutes using a Gifford-Wood homogenizer, Model 1 L form Greerco Corporation. The sample was very cloudy. The turbidity of the sample was measured using a Hach turbidimeter Model Ratio/XR. The turbidity of the demineralized water was also measured prior to addition of the vitamin E. The sample was stored at ambient temperature for six weeks. During the storage time, an immiscible layer of oil formed on top of the water. The sample was shaken well and the turbidity measured.

Sample 2: Vitamin E acetate oil (0.25 g) from Sigma-Aldrich was added to 1681 g of demineralized water. The mixture was homogenized for approximately 60 minutes, yet some immiscible oil droplets remained on the surface of the water. The turbidity of the dispersion was measured and then again after storage for six weeks at ambient temperature. Immiscible oil droplets were still on the surface of the water.

Sample 3: Vitamin E succinate powder (0.27 g) from Sigma-Aldrich was added to 1792 g of demineralized water. The mixture was homogenized for approximately 60 minutes. A small amount of powder continued to float on the surface of the water. The turbidity of the dispersion was measured and then again after storage for six weeks at ambient temperature. A small amount of powder continued to reside on the surface of the water.

Sample 4: To 1988 g of demineralized water was added 1.49 g of a 20% solution by weight of Eastman Vitamin E TPGS™ in water prepared according to the method described in Example 1. This solution was stirred at ambient temperature using a magnetic stirrer for several minutes. The Vitamin E TPGS™ dissolved almost immediately. The turbidity of the solution was measured and then measured again after storage at ambient temperature for six weeks. No solids or immiscible liquids appeared during storage.

Sample 5: To 1777 g of demineralized water was added 16.0 g of a 20% solution by weight of Eastman Vitamin E TPGS™ in water prepared according to the method described in Example 1. This solution was stirred at ambient temperature using a magnetic stirrer for several minutes. The Vitamin E TPGS™ dissolved almost immediately. The turbidity of the solution was measured and then measured again after storage at ambient temperature for six weeks. No solids or immiscible liquids appeared during storage.

Sample 6: To 1790 g of demineralized water was added 0.27 g of a mixture consisting of d,l-α-tocopheryl acetate, modified food starch, and silica. This product is commercially available from Roche Vitamins, Inc., under the name “Dry Vitamin E 15% CC”. The aqueous mixture was agitated for about thirty minutes using a magnetic stirrer. After this time, the sample appeared to have dissolved, but the solution was hazy. The turbidity of the solution was measured and then re-measured after storage for six weeks at ambient temperature.

Sample 7: To 1802 g of demineralized water was added 0.27 g of a mixture consisting of d-α-tocopheryl acetate, Polysorbate 60, and ethyl alcohol. This product is commercially available from ADM under the name “E 230 Clear®”. The mixture was agitated for about ten minutes using a magnetic stirrer. After this time, the sample appeared to have dissolved. The turbidity of the solution was measured and then re-measured after storage for six weeks at ambient temperature.

The table below shows the turbidity results for the Samples 1-7.

| | | | | | Turbidity | | Turbidity | |
|---|---|---|---|---|---|---|---|---|
| | Conc. in | | Turbidity | | (Initially | | (6 wks | |
| | demineralized | | (water | | doped | | after | |
| Vitamin E type | water | | only) | | water) | | doping) | |
| Vitamin E oil¹ | 150 +/− 5 | ppm | 0.00 | NTU | 55 | NTU | 68 | NTU |
| (Sample 1) | | | | | | | | |
| Vitamin E acetate² | 150 +/− 5 | | 0.00 | | 52 | | 61 | |
| (Sample 2) | | | | | | | | |
| Vitamin E succinate³ | 150 +/− 5 | | 0.00 | | 8 | | 22 | |
| (Sample 3) | | | | | | | | |
| Vitamin E TPGS ™⁴ | 150 +/− 5 | | 0.00 | | 0.05 | | 0.05 | |
| (Sample 4) | | | | | | | | |
| Vitamin E TPGS ™⁴ | 1800 +/− 5 | | 0.00 | | 0.1 | | 0.42 | |
| (Sample 5) | | | | | | | | |
| Vitamin E acetate | 150 +/− 5 | | 0.00 | | 39 | | 68 | |
| (Sample 6) | | | | | | | | |
| Vitamin E acetate | 150 +/− 5 | | 0.00 | | 0.6 | | 1.1 | |
| (Sample 7) | | | | | | | | |

¹“d-α-Tocopherol” oil supplied by ADM-Health under the trade name “D-Alpha ™”
²“d-α-Tocopherol acetate” commercially available from Sigma-Aldrich, Sigma catalog number T3001
³“d,l-α-Tocopherol succinate” commercially available from Sigma-Aldrich, Fluka catalog number 95255
⁴“d-α-Tocopherol polyethylene glycol 1000 succinate” supplied by Eastman Chemical Company under the name Eastman Vitamin E TPGS ™

### Example 3

### Preparation of a Sports Beverage Containing Eastman Vitamin E TPGS™

The following ingredients are added to one liter of de-mineralized water: 30 mg sodium benzoate, 100 mg ascorbic acid, 10 mg potassium chloride, 10 mg sodium chloride, 4 mg disodium hydrogen phosphate, 2 mg sodium carbonate, 2 mg magnesium carbonate and 50 mg Eastman Vitamin E TPGS™. The mixture is warmed to 50° C. and agitated until all ingredients have dissolved. Then to the warm solution is added 30 g of corn syrup solids, and 30 g of fructose and agitation is continued until dissolution is complete. The beverage is flavored by adding 0.05 g of lemon-lime flavoring. The beverage is heated for one minute at 180° F. and then packaged in PET bottles.

### Example 4

### Preparation of a Dietetic Beverage Containing Eastman Vitamin E TPGS™

Carboxymethylcellulose (350 mg) is added to one liter of water and stirred until dissolved. The following are then added: 3.9 g citric acid, 0.6 g sodium citrate, 0.5 g sodium chloride, 0.35 g potassium dihydrogen phosphate, 0.3 g of sodium benzoate, 0.05 g lemon-lime flavoring, 0.05 g Eastman Vitamin E TPGS™, and 0.3 g Splenda®) brand of sucralose sweetener. The mixture is stirred until all ingredients are dissolved, then heated for one minute at 180° F., cooled and packaged in PET bottles.

### Example 5

### Preparation of a Clear Natural Fruit Juice Containing Eastman Vitamin E TPGS™

A beverage syrup containing fruit juice is prepared as follows: malic acid (7 g) and citric acid (7 g) are mixed in water (500 g.) until dissolved. Calcium carbonate (8 g) is then added and mixed until dissolved. High fructose corn syrup-55 (357 g) is then added and mixed. Sodium benzoate (1 g) is pre-dissolved in water (80 g) and then added. Eastman Vitamin E TPGS™ (0.05 g) is dissolved in 60° C. water and added. Finally, apple juice concentrate (79 g) having a solids content of 700 Brix is added and mixed.

This beverage syrup is added to 16 oz. PET bottles at 200 g./bottle. Carbonated water is added to each bottle to make 16 oz. (volume basis) of finished carbonated beverage.

### Example 6

### Preparation of Vitamin-Fortified Dairy Product Containing Eastman Vitamin E TPGS™

To 3800 g of whole milk are added 240 micrograms of Vitamin D₃ with agitation for two minutes, followed sequentially by addition of 100 mg of ascorbic acid, 700 micrograms all-trans-retinol, and 50 mg of Eastman Vitamin E TPGS™ dissolved in 10 ml of warm water.

### Example 7

### Preparation of an Alcohol-Containing Beverage Using Eastman Vitamin E TPGS™

To 800 g of water is added 0.16 g of sodium benzoate and the mixture is stirred until dissolution is compete. Then 2.2 g of citric acid is added and stirred until dissolved, followed by 60 g of high fructose corn syrup, 0.03 g of 15% terpeneless lemon oil in ethanol, and 0.05 g Eastman Vitamin E TPGS™. After stirring for several minutes, 400 g of beer is added. The mixture is stirred and bottled.

The invention has been described in detail with particular reference to preferred embodiments thereof, but it will be understood that variations and modifications can be effected within the spirit and scope of the invention.

I claim:

1. An optically clear beverage comprising water, a water-soluble source of vitamin E, a flavoring agent and a sweetener, wherein the water-soluble source of vitamin E provides a tocopheryl content to the beverage of about 0.0005 IU/ml to about 10 IU/ml.

2. A beverage according to claim 1 wherein the beverage further comprises an anti-foaming agent and the water-soluble source of vitamin E is a polyethylene glycol ester of d,l- or d-α-tocopheryl succinate.

3. A beverage according to claim 2 wherein the water-soluble source of vitamin E provides a tocopheryl content to the beverage of about 0.002 IU/ml to about 2 IU/ml.

4. A beverage according to claim 3 wherein the water-soluble source of vitamin E provides a tocopheryl content to the beverage of about 0.02 IU/ml to about 1 IU/ml.

5. A beverage according to claim 3 wherein the sweetener is sucrose, glucose, fructose, sucralose, aspartame, acesulfame-K, alitame, saccharin, sorbitol, mannitol, lactitol, cyclamates or high fructose corn syrup and the anti-foaming agent is dimethylpolysiloxane, methylphenylpolysiloxane, oxystearin, polyethylene glycol dioleate, polyethylene/polypropylene glycol copolymers, Polysorbate 60, sodium monooleate or a mixture thereof.

6. A beverage according to claim 3 wherein the flavoring agent is chocolate, vanilla, cola, grape, pear, passion fruit, pineapple, banana or banana puree, apricot, citrus, orange, lemon, grapefruit, apple, cranberry, tomato, mango, papaya, lime, tangerine, cherry, blueberry, strawberry, raspberry, coconut, carrot or mixtures thereof, and the anti-foaming agent is dimethylpolysiloxane, methylphenylpolysiloxane, oxystearin, polyethylene glycol dioleate, polyethylene/polypropylene glycol copolymers, Polysorbate 60, sodium monooleate or a mixture thereof.

7. A beverage according to claim 3 which further comprises about 1% to about 10% ethanol by weight of the beverage.

8. A beverage according to claim 7 which comprises about 3% to about 9% ethanol by weight of the beverage.

9. A beverage according to claim 3 which further comprises a preservative selected from a sorbate, a sorbate derivative, citric acid/sodium benzoate, or a mixture thereof and the anti-foaming agent is dimethylpolysiloxane, methylphenylpolysiloxane, oxystearin, polyethylene glycol dioleate, polyethylene/polypropylene glycol copolymers, Polysorbate 60, sodium monooleate or a mixture thereof.

10. A beverage according to claim 3 which further comprises ascorbic acid, vitamin B1, vitamin B2, vitamin B6, vitamin B12, vitamin B complexes, minerals, electrolytes or mixtures thereof.

11. A beverage according to claim 1 that is optically colorless.

12. A fruit beverage comprising fruit juice or fruit flavoring, a water-soluble source of vitamin E and water, wherein the water-soluble source of vitamin E provides a tocopheryl content to the beverage of about 0.0005 IU/ml to about 10 IU/ml.

13. An optically clear fruit beverage according to claim 12 wherein the water-soluble source of vitamin E is a polyethylene glycol ester of d,l- or d-α-tocopheryl succinate.

14. A beverage according to claim 13 wherein the water-soluble source of vitamin E provides a tocopheryl content to the beverage of about.002 IU/ml to about 2 IU/ml.

15. A fruit beverage according to claim 13 wherein the fruit flavoring is a fruit juice or fruit flavor selected from grape, pear, passion fruit, pineapple, banana or banana puree, apricot, citrus, orange, lemon, grapefruit, apple, cranberry, tomato, mango, papaya, lime, tangerine, cherry, blueberry, strawberry, raspberry, coconut, carrot and mixtures thereof.

16. A fruit beverage according to claim 15 having about 1% to about 99% fruit juice or fruit flavoring.

17. A fruit beverage according to claim 16 having about 5% to about 15% fruit juice or fruit flavoring.

18. A fruit beverage according to claim 15 which further comprises sucrose, glucose, fructose, sucralose, aspartame, acesulfame-K, alitame, saccharin, sorbitol, mannitol, lactitol, cyclamates, high fructose corn syrup or mixtures thereof.

19. A fruit beverage according to claim 13 which further comprises a preservative selected from a sorbate, a sorbate derivative, citric acid/sodium benzoate, or a mixture thereof and, optionally, an anti-foaming agent.

20. A fruit beverage according to claim 13 which further comprises about 3% to about 9% ethanol by weight of the beverage.

21. A fruit beverage according to claim 13 which further comprises ascorbic acid, vitamin B1, vitamin B2, vitamin B6, vitamin B12, vitamin B complexes, minerals, electrolytes or mixtures thereof.

22. A fruit beverage according to claim 13 that is optically colorless.

23. A carbonated beverage comprising carbonated water, a water-soluble source of vitamin E, an anti-foaming agent, and a flavoring agent, wherein the water-soluble source of vitamin E provides a tocopheryl content to the beverage of about 0.0005 IU/ml to about 10 IU/ml.

24. A carbonated beverage according to claim 23 wherein the water-soluble source of vitamin E is a polyethylene glycol ester of d,l- or d-α-tocopheryl succinate.

25. A carbonated beverage according to claim 24 wherein the water-soluble source of vitamin E provides a tocopheryl content to the beverage of about 0.02 IU/ml to about 1 IU/ml.

26. A carbonated beverage according to claim 24 which further comprises sucrose, glucose, fructose, sucralose, LL-aspartame, saccharin, sorbitol, mannitol, lactitol, high fructose corn syrup, acesulfame potassium, alitame, cyclamates or mixtures thereof.

27. A carbonated beverage according to claim 24 which further comprises about 1% to about 10% ethanol by weight of the beverage.

28. A carbonated beverage according to claim 27 which comprises about 3% to about 9% ethanol by weight of the beverage.

29. A carbonated beverage according to claim 24 which further comprises a preservative selected from a sorbate, a sorbate derivative, citric acid/sodium benzoate, or a mixture thereof.

30. A carbonated beverage according to claim 24 which further comprises ascorbic acid, vitamin B1, vitamin B2, vitamin B6, vitamin B12, vitamin B complexes, minerals, electrolytes or mixtures thereof.

31. A carbonated beverage according to claim 24 wherein the flavoring agent is chocolate, vanilla, cola or a fruit juice or fruit flavor selected from grape, pear, passion fruit, pineapple, banana or banana puree, apricot, citrus, orange, lemon, grapefruit, apple, cranberry, tomato, mango, papaya, lime, tangerine, cherry, blueberry, strawberry, raspberry, coconut, carrot and mixtures thereof.

32. A carbonated beverage according to claim 24 that is optically clear.

33. A beverage concentrate comprising a flavoring agent, a sweetener, a preservative, an anti-foaming agent, a water-soluble source of vitamin E, and water.

34. A beverage concentrate according to claim 33 wherein the water-soluble source of vitamin E is a polyethylene glycol ester of d,l- or d-α-tocopheryl succinate.

35. A beverage concentrate according to claim 34 wherein the water-soluble source of vitamin E provides a tocopheryl content to the beverage of about 0.02 IU/ml to about 1 IU/ml; the sweetener is present at a level of about 40% to about 60% based on the weight of the concentrate; the preservative is a sorbate, a sorbate derivative, citric acid/sodium benzoate, or a mixture thereof; and the anti-foaming agent is dimethylpolysiloxane, methylphenylpolysiloxane, oxystearin, polyethylene glycol dioleate, polyethylene/polypropylene glycol copolymers, Polysorbate 60, sodium monooleate or a mixture thereof.

36. A beverage concentrate according to claim 34 wherein the flavoring agent is chocolate, vanilla, cola, grape, pear, passion fruit, pineapple, banana or banana puree, apricot, citrus, orange, lemon, grapefruit, apple, cranberry, tomato, mango, papaya, lime, tangerine, cherry, blueberry, strawberry, raspberry, coconut, carrot and mixtures thereof.

37. A beverage concentrate according to claim 36 wherein the sweetener is sucrose, glucose, fructose, sucralose, aspartame, saccharin, sorbitol, mannitol, lactitol, high fructose corn syrup, acesulfame, alitame, cyclamates or mixtures thereof.

38. A dairy product containing a water-soluble source of vitamin E comprising milk and a polyethylene glycol ester of d,l- or d-α-tocopheryl succinate in an amount of about 1 to about 2500 ppm.

39. A dairy product according to claim 38 which further comprises a sweetener selected from sucrose, glucose, fructose, sucralose, aspartame, saccharin, sorbitol, mannitol, lactitol, high fructose corn syrup, acesulfame, alitame and cyclamates and a flavoring agent selected from chocolate, vanilla, cola, grape, pear, passion fruit, pineapple, banana or banana puree, apricot, citrus, orange, lemon, grapefruit, apple, cranberry, tomato, mango, papaya, lime, tangerine, cherry, blueberry, strawberry, raspberry, coconut, carrot and mixtures thereof.

40. A dairy product according to claim 38 which further comprises an anti-foaming agent and a preservative selected from a sorbate, a sorbate derivative, citric acid/sodium benzoate, or a mixture thereof.

41. A dairy product according to claim 38 which further comprises ascorbic acid, vitamin D, vitamin B1, vitamin B2, vitamin B6, vitamin B12, vitamin B complexes, minerals, electrolytes or mixtures thereof.
